(19) United States
(12) Patent Application Publication
(10) Pub. No.: US 2013/0015655 A1
(43) Pub. Date: Jan. 17, 2013

(54) SWIVEL-TYPE COUPLING DEVICE FOR A RADIATOR

(71) Applicant: Claudio Rizzo, Monza (IT)

(72) Inventor: Claudio Rizzo, Monza (IT)

(21) Appl. No.: 13/634,837

(22) PCT Filed: Mar. 14, 2011
(86) PCT No.: PCT/IT2011/000071

§ 371 Date: Sep. 13, 2012

(30) Foreign Application Priority Data
Mar. 22, 2010 (IT) M122010U000081

(51) Int. Cl. F16L 27/02

(52) U.S. Cl. 285/144.1

(57) ABSTRACT

The invention relates to a swivel-type coupling device enabling relative rotation between heating fluid conveying conduits of a domestic heating radiator unit connected thereto. The swivel-type coupling device comprises: a first cup-shaped member having an axial bore extending therethrough and being connectable to a first heating fluid conveying conduit, a second cup-shaped member having an axial bore extending therethrough and being connectable to a second heating fluid conveying conduit. The cup-shaped members are coaxially arranged with their hollow portions facing one another, in order to form an axial cavity which communicates with heating fluid conveying conduits. A bushing is arranged to slide axially within the axial cavity and is capable of providing a fluid-tight seal of the axial cavity. A resilient element is interposed between the bushing and the first cup-shaped member of the coupling device.

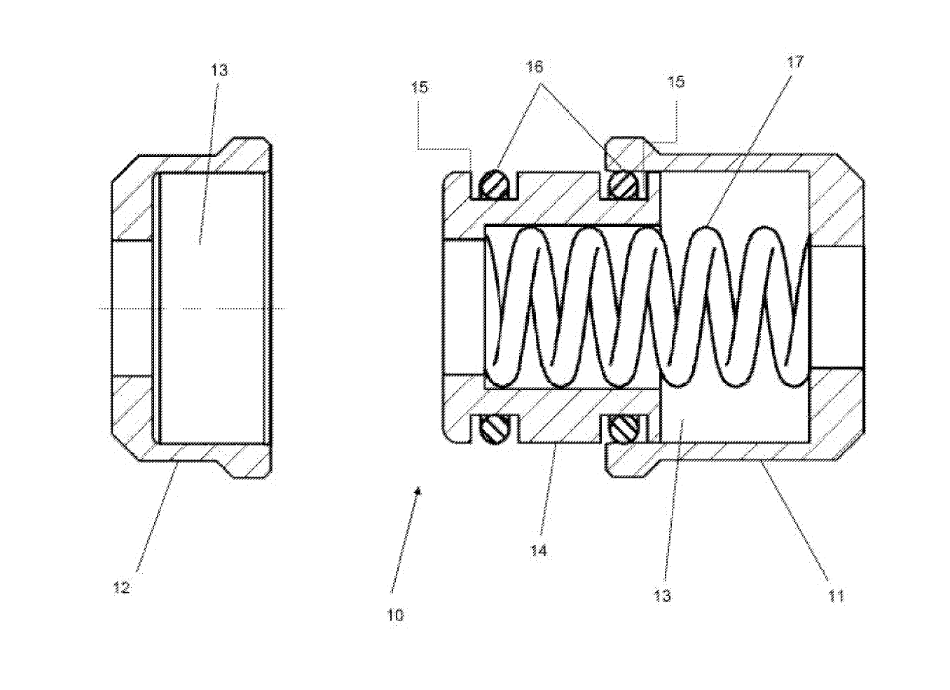

### TECHNICAL FIELD OF INVENTION

The present invention relates to a swivel-type coupling device for a domestic radiator unit, particularly, though not exclusively, for a hot water radiator unit, which enables relative rotation between heating fluid conveying conduits of the radiator unit connected thereto, whilst maintaining fluid continuity and fluid-tight sealing therebetween.

### BACKGROUND ART

A swivel-type coupling device of the kind mentioned above is disclosed, e.g., in the published European Patent Application No. 1 211 472 A1, in the name of the same Applicant of the present application. The structure of this known coupling device comprises a tubular male member, which is in fluid connection with a first heating fluid conveying conduit of the radiator unit, and a tubular female member, which is in fluid connection with a second heating fluid conveying conduit of the radiator unit, and into which the tubular male member is inserted. The tubular male member and the tubular female member are attached by welding to the first heating fluid conveying conduit and to the second heating fluid conveying conduit, respectively, of the radiator unit, and they are connected to each other by means of a connecting ring which allows a relative rotation between the two members. Annular seals are provided between the exterior surface of the tubular male member and the interior surface of the tubular female member.

This coupling device has the disadvantage that the operations for assembling the radiator unit are rather time consuming and complicated to perform and, therefore, they negatively affect the cost of the radiator unit. The reason for this is to be found in the structure of the coupling device, which requires that the tubular male and female coupling members are connected to each other before they can be attached to the heat conveying conduits of the radiator unit.

As a result, after connecting together the tubular male and female members of the coupling device, it is then necessary to perform a further assembling operation to attach the same to the heating fluid conveying conduits of the radiator unit.

This is a rather onerous task because it requires to provide a special and separate welding operation, which adds to that already necessary for joining together the parts forming the heating fluid conveying conduits of the radiator unit.

The object of the present invention is to obviate this drawback by the provision of a swivel-type coupling device having an improved structure, which allows the radiator to be assembled in a more simple and economic manner.

### SUMMARY OF INVENTION

According to the present invention, this object is achieved with a swivel-type coupling device enabling relative rotation between heating fluid conveying conduits connected thereto, characterised in that it comprises:
a first cup-shaped member having an axial bore extending therethrough and being connectable to a first of said heating fluid conveying conduits,
a second cup-shaped member having an axial bore extending therethrough and being connectable to a second of said heating fluid conveying conduits,
said first and second cup-shaped members being coaxially arranged with their hollow portions facing one another, in order to form an axial cavity which communicates with said first and second heating fluid conveying conduits,
a bushing arranged to slide axially within said axial cavity and capable of providing a fluid-tight seal of said axial cavity,
and a resilient element interposed between said bushing and said first cup-shaped member.

### BRIEF DESCRIPTION OF DRAWINGS

The present invention will now be described by way of example with reference to the embodiment illustrated in the single FIGURE of the attached drawing, in which the coupling device is shown in longitudinal section.

### DETAILED DESCRIPTION OF AN EMBODIMENT OF INVENTION

With reference to the FIGURE of the drawing, there is shown a swivel-type coupling device according to the present invention, generally designated by 10. This coupling device enables relative rotation between heating fluid conveying conduits of a domestic radiator unit (not shown) connected thereto.

As can be noticed, the coupling device 10 comprises a first cup-shaped member 11, which is provided with an axial bore extending therethrough and is intended to be connected to a first heating fluid conveying conduit of a radiator unit, and a second cup-shaped member 12, which is also provided with an axial bore extending therethrough, but is intended to be connected to a second heating fluid conveying conduit of the radiator unit. Conveniently, the cup-shaped members 11 and 12 can be attached to the heating fluid conveying conduits of the radiator unit by welding.

The cup-shaped members 11 and 12 are coaxially arranged with their hollow portions 13 facing one another in order to define, at least partially, an axial cavity which is in communication with the first and second heating fluid conveying conduits of the radiator unit, and is adapted to receive a bushing 14 therein.

The bushing 14 is arranged to slide axially within said axial cavity and is provided on its exterior surface with two spaced apart annular grooves 15. In each groove 15 an elastomeric seal 16 is located which assures a fluid-tight seal between the bushing 14 and the interior surface of the cup-shaped members 11 and 12. The bushing 14 is provided with a radially inwardly extending flange at one open end thereof. In order to keep the bushing 14 in a substantially centred position inside the axial cavity there is provided a resilient member 17 which is located coaxially within the bushing 14 and is interposed between the radially inwardly extending flange of the bushing 14 and the cup-shaped member 11. The resilient member 17 is configured to allow fluid flow through the bushing 14.

The cup-shaped members 11 and 12 are joined together by means of the bushing 14. In the assembly of the coupling device 10 the bushing 14 can be pushed inside the hollow portion of the cup-shaped member 11, thus allowing the cup-shaped members 11 and 12 to be arranged in a coaxial coupling position for connecting together the heating fluid conveying conduits of the radiator unit. The resilient member 17 assures that the bushing 14 can return to its original position to connect together the cup-shaped elements 11 and 12 once these are arranged in the coupling position.

From the foregoing it can be understood that the swivel-type coupling device according to the present invention obviates the drawback of the known couplings devices of the same type. In particular, because the bushing 14 is movable axially within the axial cavity, the cup-shaped members 11 and 12 can be easily arranged in the coaxial coupling position in the assembly of the coupling device, even if they are already connected to the heating fluid conveying conduits of the radiator unit. In this manner, the radiator can be completely assembled without being necessary a subsequent welding operation to connect the cup-shaped members 11 and 12 of the coupling device to the heat conveying conduits of the radiator unit.

1. A swivel-type coupling device (10) enabling relative rotation between heating fluid conveying conduits connected thereto, comprising:
a first cup-shaped member (11) having an axial bore extending therethrough and being connectable to a first of said heating fluid conveying conduits,
a second cup-shaped member (12) having an axial bore extending therethrough and being connectable to a second of said heating fluid conveying conduits,
said first and second cup-shaped members (11, 12) being coaxially arranged with their hollow portions (13) facing one another, in order to form an axial cavity which communicates with said first and second heating fluid conveying conduits,
a bushing (14) arranged to slide axially within said axial cavity and capable of providing a fluid-tight seal of said axial cavity,
and a resilient element (17) interposed between said bushing (14) and said first cup-shaped member (11),
wherein said bushing (14) is provided with a radially inwardly extending flange at one open end thereof and said resilient element (17) is interposed between said flange of the bushing (14) and said first cup-shaped member (11).

2. A swivel-type coupling according to claim 1, characterised in that said bushing (14) is provided on its exterior surface with two spaced apart annular grooves (15) wherein elastomeric seals 16 are located which assure a fluid-tight seal between the pin 14 and the interior surface of the cup-shaped elements 11 and 12.

3. (canceled)
